(19) United States
(12) Patent Application Publication
(10) Pub. No.: US 2006/0122093 A1
(43) Pub. Date: Jun. 8, 2006

(54) Laundry detergent composition with mixed builder system

(76) Inventor: Fides Laura Rivera Permejo, Longbenton (GB)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/295,246

(22) Filed: Dec. 6, 2005

Related U.S. Application Data
(60) Provisional application No. 60/633,776, filed on Dec. 7, 2004.
(60) Provisional application No. 60/732,510, filed on Nov. 2, 2005.

(51) Int. Cl. C11D 3/02

(52) U.S. Cl. 510/507

(57) ABSTRACT

A laundry detergent composition contains from about 1% to about 80% of a surfactant system, a mixed builder system, and the balance adjunct ingredients. The mixed builder system contains from about 0.1% to about 40% phosphate builder and from about 0.1% to about 40% of a non-phosphate builder. During use the concentration of the non-phosphate builder in the wash liquor is from about 240 ppm to about 3,600 ppm and the weight ratio of the phosphate builder to the non-phosphate builder in the wash liquor is from about 1:10 to about 10:1.

### CROSS REFERENCE TO RELATED APPLICATION

This application claims the benefit of U.S. Provisional Application No. 60/633,776, filed on Dec. 7, 2004 and U.S. Provisional 60/732,510, filed on Nov. 2, 2005.

### FIELD OF THE INVENTION

The present invention relates to detergent compositions. Specifically, the present invention relates to laundry detergent compositions.

### BACKGROUND OF THE INVENTION

Laundry detergents have long incorporated builders to enhance and complement the performance of their surfactants. Builders sequester or otherwise bind to cations in the wash water, especially in “hard water” conditions, so as to prevent them from adversely affecting the surfactant and/or the suds levels of the laundry detergent during use. In the beginning, such builders were almost exclusively phosphate builders such as the various water-soluble salts of polyphosphate, orthophosphate, and metaphosphate. However, phosphate builders are regulated by law in certain locations, and have been subject to severe price fluctuations and scarcity. Thus, it is desirable to reduce overall phosphate builder levels.

Current non-phosphate builders typically include zeolites and silicates such as the amorphous silicates. In detergent compositions where zeolites and silicates are used as builders, they are typically used to completely replace the phosphate builders. However, it is generally recognized that neither zeolites nor silicates in and of themselves perform as well as phosphate builders, especially with respect to whiteness performance. However, zeolites and silicates may be expensive, are mostly insoluble, and thus may adversely affect product solubility. In addition, the insoluble portions of a detergent may deposit onto a fabric or a garment, and thus adversely affect the whiteness of whites and brightness of colored garments. In extreme cases, the fabric and/or the wash liquor may feel gritty or sandy due to the insoluble particulates. This can negatively affect the entire washing experience, especially in hand washing geographies. Zeolites are also known to preferentially sequester calcium ions only, and at lower kinetics than other builders.

In some cases, zeolites have been used in certain manufacturing processes as a dusting agent, whereby finished granules, especially certain agglomerates, are dusted with finely divided zeolite to prevent them from sticking together. Such dusting processes have been used both in phosphate builder-containing detergents and non-phosphate builder-containing detergents. When used as a dusting agent, zeolite is typically less than about 3%, and usually about 1%, of the total laundry detergent composition by weight.

Accordingly, the need exists for a builder system which balances performance with the limitations of the various builders.

### SUMMARY OF THE INVENTION

The present invention relates to a laundry detergent composition with from about 1% to about 80% of a surfactant system, a mixed builder system, and the balance adjunct ingredients. The mixed builder system contains from about 0.1% to about 40% phosphate builder and from about 0.1% to about 40% of a non-phosphate builder. During use, the concentration of the non-phosphate builder in the wash liquor is from about 240 ppm to about 3,600 ppm and the weight ratio of the phosphate builder to the non-phosphate builder in the wash liquor is from about 1:10 to about 10:1.

It has now been found that the use of such a mixed builder system provides surprisingly good performance while allowing greater formula flexibility. Such a mixed builder system may also reduce the total amount of builder needed in the formulation while providing parity or even improved performance in areas such as sudsing, dingy clean up and whitening performance, greasy and non-greasy stain removal, hardness ion sequestration and/or surfactant solubility.

### DETAILED DESCRIPTION OF THE INVENTION

All temperatures herein are in degrees Celsius (° C.) unless otherwise indicated. All percentages and ratios are by weight of the final laundry detergent composition, unless specifically stated. As used herein, the term “comprising” means that other steps, ingredients, elements, etc. which do not adversely affect the end result can be added. This term encompasses the terms “consisting of” and “consisting essentially of”.

The present invention relates to a laundry detergent composition with from about 1% to about 80% of a surfactant system, a mixed builder system, and the balance adjunct ingredients. The mixed builder system contains from about 0.1% to about 40% phosphate builder and from about 0.1% to about 40% of a non-phosphate builder. The use of such a mixed builder system provides surprisingly good performance while allowing greater formula flexibility. Such a mixed builder system may also reduce the total amount of builder needed in the formulation while providing parity or even improved performance in areas such as sudsing, dingy clean up and whitening performance, greasy and non-greasy stain removal, hardness ion sequestration and/or surfactant solubility.

Due to the significant impact on sudsing, the present invention is especially preferred for use in a laundry detergent designed for hand washing of laundry.

Without intending to be limited by theory, it is believed that a mixed phosphate and non-phosphate (e.g., zeolite) builder system, may provide these benefits due to an optimized balance between the control of calcium ions and yet retain a certain amount of magnesium ions in the wash liquor (i.e., the washing solution). It has been found that a certain amount of magnesium ions in the water can improve overall cleaning performance. Therefore, it is important that the concentration of the non-phosphate builder be at a level of from about 240 ppm to about 3,600 ppm in the wash liquor. In an embodiment of the invention, the concentration of the non-phosphate builder be at a level of from about 280 ppm to about 1,800 ppm, or from about 300 ppm to about 750 ppm in the wash liquor. Furthermore, it is important that the weight ratio of the phosphate builder to non-phosphate builder in the wash liquor be from about 1:10 to about 10:1, or 1:5 to about 5:1, or from about 1:1 to about 3:1. In an embodiment of the invention the concentration of phosphate builder in the wash liquor may be from about 50 ppm to about 3,600 ppm, or from about 100 ppm to about 1,800 ppm, or from about 220 to about 750 ppm.

It is known that most zeolites preferentially bind calcium ions instead of magnesium ions in solution. These magnesium ions are then available as counterions to bridge surfactant micelles. These magnesium-bridged surfactants are known to have lower Kraft point than many other surfactants, including calcium-bridged surfactants, and are therefore more soluble. This improved solubility results in more surfactant which is available for cleaning. This benefit is usually seen among soils and stains which are more sensitive to surfactants, e.g., greasy and oily stains, as well as enzymatic stains. This mechanism results to better calcium control, and thus phosphates are free to perform other functions such as providing enhanced dispersancy. These benefits are then seen both on soil and stains sensitive to surfactants as well as those which benefit from improved dispersancy, e.g., particulates/clays and dingy items. It is also possible that selective/preferential binding of different hard water ions by the different components of the mixed builder system and the different binding kinetics is resulting in the significant benefits seen. In fact, the present invention may allow the total builder level to be reduced by almost half, from either a pure phosphate builder or pure non-phosphate builder system, while providing parity or even improved performance. This in turn results in significant formula flexibility, cost reduction, and/or improved overall cleaning effective on diverse soils and stains. Such formulations may also benefit the environment in some cases.

The surfactant typically is selected from an anionic surfactant, a nonionic surfactant, a cationic surfactant, a zwitterionic surfactant, an ampholytic surfactant, a semi-polar nonionic surfactant, a gemini surfactant, and a mixture thereof; or an anionic surfactant, a nonionic surfactant, a zwitterionic surfactant, and a mixture thereof; or an anionic surfactant, a nonionic surfactant, and a mixture thereof. The surfactant is typically present at from about 1% to about 80%, or from about 5% to about 50%, or from about 10% to about 35%.

The anionic surfactant useful herein has an alkyl chain length of from about 6 carbon atoms (C₆), to about 22 carbon atoms (C₂₂), and are well-known in the art of detergent formulations. Nonlimiting examples of anionic surfactants useful herein include:
a) linear alkyl benzene sulfonates (LAS), especially C₁₁-C₁₈ LAS;
b) primary, branched-chain and random alkyl sulfates (AS), especially C₁₀-C₂₀ AS;
c) secondary (2,3) alkyl sulfates having formulas (I) and (II), especially C₁₀-C₁₈ secondary alkyl sulfates: 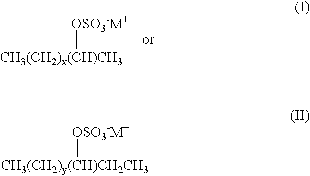
M in formulas (I) and (II) is hydrogen or a cation which provides charge neutrality. For the purposes of the present invention, all M units, whether associated with a surfactant or adjunct ingredient, can either be a hydrogen atom or a cation depending upon the form isolated by the artisan or the relative pH of the system wherein the compound is used. Non-limiting examples of preferred cations include sodium, potassium, ammonium, and mixtures thereof. Wherein x is an integer of at least about 7, or at least about 9; and y is an integer of at least 8, or at least about 9;
d) alkyl alkoxy sulfates (AEₓS), especially C₁₀-C₁₈ AEₓS wherein x is preferably from about 1 to about 30, or from about 2 to about 10;
e) alkyl alkoxy carboxylates, especially C₆-C₁₈ alkyl alkoxy carboxylates, preferably comprising about 1-5 ethoxy units;
f) mid-chain branched alkyl sulfates as discussed in U.S. Pat. No. 6,020,303 to Cripe, et al., granted on Feb. 1, 2000; and U.S. Pat. No. 6,060,443 to Cripe, et al., granted on May 9, 2000;
g) mid-chain branched alkyl alkoxy sulfates as discussed in U.S. Pat. No. 6,008,181 to Cripe, et al., granted on Dec. 28, 1999; and U.S. Pat. No. 6,020,303 to Cripe, et al., granted on Feb. 1, 2000;
i) methyl ester sulfonate (MES);
i) alpha-olefin sulfonate (AOS); and
k) primary, branched chain and random alkyl or alkenyl carboxylates, especially those having from about 6 to about 18 carbon atoms.

Generally, the present invention contains from about 0.1% to about 25%, or from about 0.5% to about 20%, or from about 1% to about 17% by weight of the final composition of a nonionic surfactant. Non-limiting examples of nonionic surfactants include:
a) C₁₂-C₁₈ alkyl ethoxylates, such as, the NEODOL® nonionic surfactants from Shell Corp.;
b) C₆-C₁₂ alkyl phenol alkoxylates wherein the alkoxylate units are a mixture of ethyleneoxy and propyleneoxy units;
c) C₁₂-C₁₈ alcohol and C₆-C₁₂ alkyl phenol condensates with ethylene oxide/propylene oxide block polymers such as Pluronic® from BASF Aktiengesellschaft;
d) C₁₄-C₂₂ mid-chain branched alcohols (BA) as discussed in U.S. Pat. No. 6,150,322 to Singleton, et al., granted on Nov. 21, 2000;
e) C₁₄-C₂₂ mid-chain branched alkyl alkoxylates (BAEₓ) where x is from about 1-30, as discussed in U.S. Pat. No. 6,153,577 to Cripe, et al., granted on Nov. 28, 2000; U.S. Pat. No. 6,020,303 to Cripe, et al., granted on Feb. 1, 2000; and U.S. Pat. No. 6,093,856 to Cripe, et al., granted on Jul. 25, 2000;
f) polyhydroxy fatty acid amides as discussed in U.S. Pat. No. 5,332,528 to Pan and Gosselink, granted on Jul. 26, 1994; PCT Publication WO 92/06162 A1 to Murch, et al., published on Apr. 16, 1992; PCT Publication WO 93/19146 A1 to Fu, et al., published on Sep. 30, 1993; PCT Publication WO 93/19038 A1 to Conner, et al., published on Sep. 30, 1993; and PCT Publication WO 94/09099 A1 to Blake, et al., published on Apr. 28, 1994;
g) ether-capped poly(oxyalkylated) alcohol surfactants as discussed in U.S. Pat. No. 6,482,994 to Scheper and Sivik, granted on Nov. 19, 2002; and PCT Publication WO 01/42408 A2 to Sivik, et al., published on Jun. 14, 2001.

Non-limiting examples of a cationic surfactant includes: the quaternary ammonium surfactants, which can have up to 26 carbon atoms.
a) alkoxylate quaternary ammonium (AQA) surfactants as discussed in U.S. Pat. No. 6,136,769;
b) dimethyl hydroxyethyl quaternary ammonium as discussed in U.S. Pat. No. 6,004,922;
c) polyamine cationic surfactants as discussed in WO 98/35002, WO 98/35003, WO 98/35004, WO 98/35005, and WO 98/35006;
d) cationic ester surfactants as discussed in U.S. Pat. Nos. 4,228,042, 4,239,660 4,260,529 and U.S. Pat. No. 6,022,844; and
e) amino surfactants as discussed in U.S. Pat. No. 6,221,825 and WO 00/47708, specifically amido propyldimethyl amine.

Non-limiting examples of a zwitterionic surfactant includes: derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 to Laughlin et al., issued Dec. 30, 1975 at column 19, line 38 through column 22, line 48, for examples of zwitterionic surfactants; betaine, including alkyl dimethyl betaine and cocodimethyl amidopropyl betaine, C₈ to C₁₈ (preferably C₁₂ to C₁₈) amine oxides and sulfo and hydroxy betaines, such as N-alkyl-N,N-dimethylammino-1-propane sulfonate where the alkyl group can be C₈ to C₁₈, preferably C₁₀ to C₁₄.

Non-limiting examples of ampholytic surfactants include: aliphatic derivatives of secondary or tertiary amines, or aliphatic derivatives of heterocyclic secondary and tertiary amines in which the aliphatic radical can be straight- or branched-chain. Typically, one of the aliphatic substituents contains at least about 8 carbon atoms, typically from about 8 to about 18 carbon atoms, and at least one contains an anionic water-solubilizing group, e.g. carboxy, sulfonate, sulfate, etc. See, e.g., U.S. Pat. No. 3,929,678 to Laughlin, et al., issued Dec. 30, 1975 at column 19, lines 18-35, for examples of ampholytic surfactants.

Non-limiting examples of semi-polar nonionic surfactants include: water-soluble amine oxides containing one alkyl moiety of from about 10 to about 18 carbon atoms and 2 moieties selected from the group consisting of alkyl groups and hydroxyalkyl groups containing from about 1 to about 3 carbon atoms; water-soluble phosphine oxides containing one alkyl moiety of from about 10 to about 18 carbon atoms and 2 moieties selected from the group consisting of alkyl groups and hydroxyalkyl groups containing from about 1 to about 3 carbon atoms; and water-soluble sulfoxides containing one alkyl moiety of from about 10 to about 18 carbon atoms and a moiety selected from the group consisting of alkyl and hydroxyalkyl moieties of from about 1 to about 3 carbon atoms. See WO 01/32816; U.S. Pat. No. 4,681,704; and U.S. Pat. No. 4,133,779.

Gemini Surfactants are compounds having at least two hydrophobic groups and at least two hydrophilic groups per molecule have been introduced. These have become known as “gemini surfactants” in the literature, e.g., Chemtech, March 1993, pp. 30-33, and J. Am. Chem. Soc., 115, 10083-90 (1993) and the references cited therein.

These surfactants are typically commodities that are readily-available from a variety of suppliers around the world, in any quantity and quality desired.

The mixed builder system herein includes from about 0.1% to about 40%; or from about 1% to about 20%; or from about 3% to about 15%; or from about 5% to about 12% phosphate builder and from about 0.1% to about 40%; or from about 1% to about 20%; or from about 3% to about 15%; or from about 5% to about 12% non-phosphate builder. Subject to the previously-described conditions regarding the weight ratio of the phosphate builder to the non-phosphate builder in the wash liquor, the weight ratio of phosphate builder to non-phosphate builder in the detergent formula is typically from about 1:10 to about 10:1 or from about 1:10 to about 5:1; or from about 1:2 to about 2:1.

The phosphate builder herein includes, but is not limited to, the alkali metal, ammonium and alkanolammonium salts of polyphosphate, orthophosphate, and/or metaphosphate; the alkali metal salts of polyphosphate, orthophosphate, and/or metaphosphate; or the sodium and potassium salts of polyphosphate, orthophosphate, and/or metaphosphate; or the sodium salts of polyphosphate, orthophosphate, and/or metaphosphate; or sodium tripolyphosphate.

Non-phosphate builders include the alkali metal silicates, alkaline earth and alkali metal carbonates, aluminosilicate builders, polycarboxylate compounds, ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof. In an embodiment herein, the non-phosphate builder includes a zeolite, especially zeolite A, zeolite X, zeolite P, zeolite MAP, and a mixture thereof. In an embodiment herein, the non-phosphate builder includes an alkali metal silicate, a zeolite, and a mixture thereof. In an embodiment herein the non-phosphate builder includes sodium silicate having a value of from about 1.4 R to about 2.0 R, or about 1.6 R.

The balance of the laundry detergent is composed of adjunct ingredients such as a brightener, enzymes, a bluing agent, an enzyme, a perfume, a suds suppressor,

Brighteners useful herein typically convert ultraviolet and other non-visible light into visible light, thereby appearing to make fabric and clothes brighter, whiter, and/or their colors more vibrant. Non-limiting examples of brighteners useful herein include brightener 15, brightener 49, brightener, manufactured by Ciba Geigy, Paramount, Shanghai Yulong and others.

The bluing agent useful herein is typically a slightly bluish dye and/or pigment which attaches to fabrics and which thereby helps to hide yellowish tinges and colors on fabrics so as to make the fabric appear whiter. Bluing agents suitable for use herein include: Polar Brilliant Blue GAW 180 percent sold by Ciba-Geigy S. A., Basel, Switzerland (similar to C.I. [“Color Index”] 61135—Acid Blue 127); FD&C Blue No. 1 (C.I. 42090), Rhodamine BM (C.I. 45170); Pontacyl Light Yellow 36 (similar to C.I. 18820); Acid yellow 23; Pigmasol blue; Acid blue 3; Polar Brilliant Blue RAW (C.I. 61585—Acid Blue 80); Phthalocyanine Blue (C.I. 74160); Phthalocyanine Green (C.I. 74260); and Ultramarine Blue (C.I. 77007—Pigment Blue 29). Additional examples of suitable bluing agents are described in U.S. Pat. No. 3,931,037 issued Jan. 6, 1976 to Hall and U.S. Pat. No. 5,605,883 issued Feb. 25, 1997 to Iliff, et al. In an embodiment herein the bluing agent is ultramarine blue which is available form a variety of suppliers, worldwide.

Enzymes useful herein include proteases like subtilisins from Bacillus [e.g. subtilis, lentus, licheniformis, amyloliquefaciens (BPN, BPN′), alcalophilus,] e.g. Esperase®, Alcalase®, Everlase® and Savinase® (Novozymes), BLAP and variants thereof from Henkel. Further proteases are described in EP 130756, WO 91/06637, WO 95/10591 and WO 99/20726. Amylases (α and/or β) are described in WO 94/02597 and WO 96/23873. Commercial examples include Purafect Ox Am® [available from Genencor] and Termamyl®, Natalase®, Ban® Fungamyl® and Duramyl® [all ex. Novozymes]. Cellulases include bacterial or fungal cellulases, e.g. produced by Humicola insolens, particularly DSM 1800, e.g. 50 Kda and ^{˜}43 kD [Carezyme®]. Also suitable cellulases are the EGIII cellulases from Trichodenna longibrachiatum. Suitable lipases include those produced by Pseudomonas and Chromobacter groups. Preferred are e.g. Lipolase®, Lipolase Ultra®, Lipoprime® and Lipex® from Novozymes. Also suitable are cutinases [EC 3.1.1.50] and esterases. Carbohydrases e.g. mannanase (U.S. Pat. No. 6,060,299), pectate lyase (WO 99/27083) cyclomaltodextringlucanotransferase (WO 96/33267) xyloglucanase (WO 99/02663). Bleaching enzymes include e.g., peroxidases, laccases, oxygenases, etc.

It is common practice to modify wild-type enzymes via protein/genetic engineering techniques in order to optimize their performance in the detergent compositions. Enzymes levels in detergents in general are from 0.0001% to 2%, preferably 0.001% to 0.2%, more preferably 0.005% to 0.1% pure enzyme (weight % of composition).

Enzymes can be stabilized using any known stabilizer system like calcium and/or magnesium compounds, boron compounds and substituted boric acids, aromatic borate esters, peptides and peptide derivatives, polyols, low molecular weight carboxylates, relatively hydrophobic organic compounds [e.g. certain esters, diakyl glycol ethers, alcohols or alcohol alkoxylates], alkyl ether carboxylate in addition to a calcium ion source, benzamidine hypochlorite, lower aliphatic alcohols and carboxylic acids, N,N-bis(carbomethyl) serine salts; (meth)acrylic acid-(meth)acrylic acid ester copolymer and PEG; lignin compound, polyamide oligomer, glycolic acid or its salts; poly hexa methylene bi guanide or N,N-bis-3-amino-propyl-dodecyl amine or salt; and mixtures thereof.

The perfume useful herein is added to provide aesthetic impact to the fabric either during or after laundering. Such perfumes available from a variety of suppliers such as Givaudan, International Flavors & Fragrances, Takasago, etc.

The laundry detergent composition is typically a granular laundry detergent composition formed by spray drying, agglomeration, and/or a combination thereof. Such a granular laundry detergent composition is usually composed of particles having a weight-average particle size (diameter) of from about 50μ to about 3 mm, or from about 100μ to about 1 mm Processes for forming such a detergent composition are well-known in the art.

The laundry detergent compositions herein are especially well-suited for use in a hand-washing context and in hard water conditions where the water hardness is between about 17 ppm to about 600 ppm; or from about 34 ppm to about 340 ppm; or from about 51 ppm to about 300 ppm of hard water ions such as Ca²⁺, Mg²⁺, etc., or such as Ca²⁺ and Mg²⁺.

### EXAMPLE 1

The following formulas are produced.

| | % | Comparative | | | | |
|---|---|---|---|---|---|---|
| | active | example | A | B | C | D |
| LAS | 96.5 | 18 | 20.5 | 20.5 | 20.5 | 17 |
| AES | 71 | 1 | 0.5 | 0.5 | 0.5 | 0.8 |
| Cationic surfactant | 40 | 0.6 | — | — | — | 0.5 |
| Sodium tripolyphosphate | 100 | 25 | 6 | 6 | 6 | 10 |
| Zeolite A | 100 | 3 (dusted) | 6.4 | 6.4 | 6.4 | 0.5 |
| Protease enzyme | 100 | 0.45 | 0.15 | 0.15 | 0.15 | 0.3 |
| Carboxy Methyl Cellulose | 72 | 0.2 | 0.13 | 0.13 | 0.13 | 0.13 |
| Brightener 15# | 100 | 0.01 | 0.06 | 0.06 | 0.06 | 0.06 |
| Brightener 49# | 100 | 0.06 | 0.04 | 0.04 | 0.04 | 0.04 |
| Sodium Carbonate | 100 | 20 | 20 | 20 | 20 | 20 |
| Sodium Silicate (solids) | 45 | 0.6 | 0.5 | 0.5 | 0.5 | 0.5 |
| Perfume | 100 | 0.44 | 0.3 | 0.3 | 0.3 | 0.3 |
| Fillers, moisture, other adjunct | 100 | balance | balance | balance | balance | balance |
| ingredients | | | | | | |
| Non-phosphate builder in the | | 236 ppm | 611 ppm | 611 ppm | 611 ppm | 80 ppm |
| wash liquor | | | | | | |
| Weight ratio of phosphate | | 7.7:1 | 1:1.1 | 1:1.1 | 1:1.1 | 11:1 |
| builder:non-phosphate builder | | | | | | |
| in the wash liquor | | | | | | |

Formulas A-C are high sudsing, hand washing compositions which provide performance which is comparable to, or better than the comparative example, even though formulas A-C contain a significantly lower amount of total builder system. Formula D is a comparative example.

### EXAMPLE 2

The following formulas are prepared.

| | % | Comparative | | | | |
|---|---|---|---|---|---|---|
| | active | example | A | B | C | D |
| LAS | 96.5 | 18 | 20.5 | 20.0 | 20.5 | 20 |
| AES | 71 | 1 | 0.5 | — | 0.5 | — |
| Sodium tripolyphosphate | 100 | 25 | 6 | 6 | 6 | 6 |
| Zeolite A | 100 | 3 (dusted) | 6.4 | 6.0 | 6.4 | 6 |
| Protease enzyme | 100 | 0.45 | 0.15 | 0.15 | 0.15 | 0.15 |
| Carboxy Methyl Cellulose | 72 | 0.2 | 0.13 | 0.13 | 0.13 | 0.13 |
| Brightener 15# | 100 | 0.01 | 0.06 | 0.06 | 0.06 | 0.06 |
| Brightener 49# | 100 | 0.06 | 0.04 | 0.04 | 0.04 | 0.04 |
| Sodium Carbonate | 100 | 20 | 20 | 20 | 20 | 20 |
| Sodium Silicate (solids) | 45 | 0.6 | 1 | 1 | 1 | 1 |
| Perfume | 100 | 0.44 | 0.3 | 0.3 | 0.3 | 0.3 |
| Fillers, moisture, other adjunct | 100 | balance | balance | balance | balance | balance |
| ingredients | | | | | | |
| Non-phosphate builder in the | | 236 ppm | 611 ppm | 540 ppm | 505 ppm | 473 ppm |
| wash liquor | | | | | | |
| Weight ratio of phosphate | | 7.7:1 | 1:1.1 | 1:1 | 1:1.1 | 1:1 |
| builder:non-phosphate builder | | | | | | |
| in the wash liquor | | | | | | |

Formulas A-D are high sudsing, hand washing compositions which provide performance which is comparable to, or better than the comparative example, even though formulas A-D contain a significantly lower amount of total builder system.

### EXAMPLE 3

| | % | | | | |
|---|---|---|---|---|---|
| | active | A | B | C | D |
| LAS | 96.5 | 14.4 | 20.5 | 24.6 | 25.2 |
| AES | 71 | 0.4 | 0.5 | 0.6 | 0.6 |
| DMP | 100 | 4.8 | 6 | 7.2 | 11 |
| Zeolite A | 100 | 5.1 | 6.4 | 7.7 | 11 |
| Protease enzyme | 100 | 0.07 | 0.1 | 0.13 | 0.13 |
| Carboxy Methyl | 72 | 0.10 | 0.13 | 0.16 | 0.16 |
| Cellulose | | | | | |
| Brightener 15# | 100 | 0.05 | 0.06 | 0.07 | 0.06 |
| Brightener 49# | 100 | 0.03 | 0.04 | 0.05 | 0.04 |
| Sodium Carbonate | 100 | 4.5 | 5.6 | 6.7 | 9 |
| Sodium Silicate | 45 | 7.6 | 9.5 | 11.4 | 11.4 |
| (solids) | | | | | |
| Perfume | 100 | 0.2 | 0.3 | 0.4 | 0.3 |
| Fillers, moisture, | 100 | balance | balance | balance | balance |
| other adjunct | | | | | |
| ingredients | | | | | |

### EXAMPLE 4

Formulas A-C in EXAMPLE 1 are prepared, further containing 0.1% lipase enzyme (Lipex®). Formulas A-C in EXAMPLE 1 are also prepared, further containing 0.2% lipase enzyme (Lipex®).

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A laundry detergent composition comprising:
A. from about 1% to about 80% of a surfactant;
B. a mixed builder system comprising:
i. from about 0.1% to about 40% phosphate builder; and
ii. from about 0.1% to about 40% of a non-phosphate builder; and
C. the balance adjunct detergent ingredients,
wherein the concentration of the non-phosphate builder during use in the wash liquor is from about 240 ppm to about 3,600 ppm, and wherein the weight ratio of the phosphate builder to non-phosphate builder in the wash liquor is from about 1:10 to about 10:1.

2. The laundry detergent composition of claim 1, wherein the laundry detergent composition is a granular laundry detergent composition.

3. The laundry detergent composition of claim 1, wherein the ratio of phosphate builder to non-phosphate builder in the wash liquor is from about 1:5 to about 5:1.

4. The laundry detergent composition of claim 1, wherein the non-phosphate builder comprises zeolite.

5. The laundry detergent composition of claim 1, wherein the adjunct ingredients comprise a brightener.

6. The laundry detergent composition of claim 1, wherein the adjunct ingredients comprise a bluing agent.

7. The laundry detergent composition of claim 1, wherein phosphate is present at from about 1% to about 20%.

8. The laundry detergent composition of claim 1, wherein the surfactant comprises an anionic surfactant.

9. The laundry detergent composition of claim 1, wherein the adjunct ingredients comprise an enzyme.

10. The laundry detergent composition of claim 8, wherein the anionic surfactant comprises alkyl benzene sulfonate.
